(19) United States
(12) Patent Application Publication
(10) Pub. No.: US 2025/0027706 A1
(43) Pub. Date: Jan. 23, 2025

(54) REFRIGERATOR

(71) Applicant: LG ELECTRONICS INC., Seoul (KR)

(72) Inventors: Jungil SHIN, Seoul (KR); Sunghyun YUN, Seoul (KR); Seonwoo NAM, Seoul (KR)

(73) Assignee: LG ELECTRONICS INC., Seoul (KR)

(21) Appl. No.: 18/757,831

(22) Filed: Jun. 28, 2024

(30) Foreign Application Priority Data
Jul. 17, 2023 (KR) 10-2023-0092463

(51) Int. Cl. F25D 23/02

(52) U.S. Cl. CPC F25D 23/028

(57) ABSTRACT

An embodiment of the present disclosure relates to a refrigerator, and the refrigerator includes a cabinet forming a storage space; and a door configured to open and close the storage space, in which the door includes an out plate having a bending portion that forms a front surface of the door made of metal and is bent backward; a door liner forming a rear surface of the door; a door cap having an insertion groove that connects the out plate and the door liner to form an outer surface of the door and into which the bending portion is inserted; and an insulation material formed by injecting a foaming liquid into the inside of the door, and an inlet portion is formed in the door cap, which communicates with the insertion groove and guides the foaming liquid into the insertion groove.

### CROSS-REFERENCE TO RELATED APPLICATIONS

The present application claims priority under 35 U.S.C. 119 of Korean Patent Application No. 10-2023-0092463, filed on Jul. 17, 2023, in the Republic of Korea, which is hereby incorporated by reference in its entirety.

### BACKGROUND

The present disclosure relates to a refrigerator.

In general, a refrigerator is a home appliance that allows food to be stored at low temperatures in an internal storage space shielded by a door. To this end, the refrigerator is designed to keep stored food in optimal condition by cooling the inside of the storage space using cold air generated through heat exchange with the refrigerant circulating in the refrigeration cycle.

Recently, the refrigerator is gradually becoming larger and more multi-functional in accordance with changes in eating habits and the trend of higher quality products, and the refrigerator equipped with various structures and convenience devices are being released to ensure user convenience and efficient use of internal space.

The storage space of the refrigerator may be opened and closed by a door. In addition, the refrigerator may be classified into various types according to the arrangement of the storage space and the structure of the door that opens and closes the storage space.

Typically, the door of a refrigerator may have a structure that opens and closes by rotation or by sliding in and out. Additionally, the handle may have a structure in which the handle protrudes or is recessed in order to open the door. In addition, the front surface of the refrigerator door may be made of a metal material to have a structure that makes the outer appearance thereof stand out more.

On the other hand, when the front surface of the refrigerator door is made of a metal material and the end portion of the door is not completely filled with insulation material, there is a problem that the front surface of the door moves or swings when the user presses the end portion of the door with his or her hand.

In particular, this problem becomes more serious in the case of a door that the user opens and closes by holding or pressing the end portion of the door.

### SUMMARY

An object of an embodiment of the present disclosure is to provide a refrigerator that prevents movement of the front surface of the door.

An object of an embodiment of the present disclosure is to provide a refrigerator that allows the inflow of foaming liquid that forms an insulation material at the end portion of the door.

An object of an embodiment of the present disclosure is to provide a refrigerator that improves the feeling of operation when a user operates the door.

A refrigerator according to an embodiment of the present disclosure includes a cabinet forming a storage space; and a door configured to open and close the storage space, in which the door includes an out plate having a bending portion that forms a front surface of the door made of metal and is bent backward; a door liner forming a rear surface of the door; a door cap having an insertion groove that connects the out plate and the door liner to form an outer surface of the door and into which the bending portion is inserted; and an insulation material formed by injecting a foaming liquid into the inside of the door, and an inlet portion may be formed in the door cap, which communicates with the insertion groove and guides the foaming liquid into the insertion groove.

A recessed handle may be formed in the door cap so that a user can hold the handle to open the door.

The door cap may include an upper door cap forming an upper surface of the door, and a lower door cap forming a lower surface of the door, and the handle and an inlet portion may be formed on the upper door cap.

The door cap may include a front part configured to support the out plate from the rear and in which the insertion groove is formed, and the inlet portion may penetrate the bottom of the insertion groove connecting the handle and the front part.

The door cap may include a front part configured to support the out plate from the rear, the insertion groove may be recessed in the front part, and the inlet portion may be formed in a shape of a hole penetrating the bottom of the insertion groove.

The insertion groove may be provided with a plurality of ribs configured to support the bending portion, and the inlet portion may be located between the plurality of ribs.

A pair of injection holes through which the foaming liquid is sequentially injected may be formed at the door, and a pair of the inlet portions may be spaced apart from each other, and the diameter of the inlet portion closest to the injection hole through which the foaming liquid is first injected is smaller than the diameter of the other inlet portion.

A blocking portion may be formed inside the insertion groove, and the blocking portion may protrude to block at least a portion of the inlet portion from above.

The insertion groove may be provided with a plurality of ribs configured to support the bending portion, and the blocking portion may extend to pass through a plurality of ribs.

The door cap may include a handle recessed to put the user's hand therein; and a door opening device including an operation member configured to operate by the user and a push member configured to push the cabinet to open the door in conjunction with the operation of the operating member, and the plurality of inlet portions may be disposed on both sides of the door opening device.

The insertion groove may extend from the front of the door opening device to pass through the door opening device in left and right direction, and the foaming liquid flowing into the inlet portion may fill the insertion groove above the door opening device.

The inlet portion may includes of a plurality of holes disposed at regular intervals, and the plurality of inlet portion may be formed so that the diameter of the holes becomes larger as the distance from the door opening device increases.

The door cap may include a front part configured to support the out plate from the rear, the insertion groove and the inlet portion may be formed at the front part, and the inlet portion may be recessed from the lower end of the front part to the insertion groove, and the foaming liquid may pass between the out plate and the inlet portion and heads toward the insertion groove.

The inlet portion may be formed to be stepped from the front surface of the front part.

A plurality of ribs may be formed along the insertion groove, and a greater number of the plurality of ribs may be disposed in an area outside the inlet portion than in an area of the inlet portion with respect to the inlet portion.

A door sheet in contact with the foaming liquid may be provided on a rear surface of the out plate, the door sheet may include a first door sheet extending upward from the lower end of the out plate; and a second door sheet disposed above the first door sheet, and the first door sheet and the second door sheet may be formed of different materials.

The first door sheet may be made of a compressible material and be thicker than the second door sheet.

The door cap may be provided with a door opening device that assists in opening the door, and at least a portion of the second door sheet may overlap the door opening device.

The refrigerator may further include a rail connecting the door and the cabinet and configured to opening and closing the storage space by pulling the door in and out.

The refrigerator may further include a hinge connecting the door and the cabinet and configured to opening and closing the storage space by rotating the door.

The following effects may be expected from the refrigerator according to the proposed embodiment.

The refrigerator according to an embodiment of the present disclosure has an inlet portion formed in the door cap so that the foaming liquid inside the door may flow into the insertion groove where the bending portion of the out plate is inserted. In addition, when the foam liquid is cured to form an insulation material, the out plate may be more firmly fixed and supported at the upper end of the door.

Therefore, even if the user operates or presses the upper end of the door, the front surface of the door may be prevented from moving or swinging.

In addition, when the handle is recessed in the door cap, the user holds the upper end of the door. At this time, since the inside of the insertion groove is filled with an insulation material, the feeling of operation may be further improved by preventing the front surface of the door from moving or swinging while the user holds or operates the handle.

In particular, when a door opening device is disposed on the handle to assist in opening the door, there is an advantage in that the front surface of the door may be prevented from moving or swinging even when the door opening device is operated.

Additionally, the front surface of the door opening device is in simple contact with the out plate, and if the out plate contracts or expands due to changes in ambient temperature or the like, a problem may occur where the front surface of the door moves or swings. However, in the present disclosure, an insulation material is formed inside the insertion groove above the door opening device to additionally fix the outdoor door at the position where the door opening device is placed, thereby preventing the front surface of the door from moving or swinging.

In other words, due to the arrangement of the door opening device, a portion of the outer plate is not in contact with the insulation material, which may make it vulnerable to movement of the front surface of the door, but, by forming an insulation material in the insertion groove above the door opening device, the outer plate may be additionally fixed. In particular, it is possible to prevent the upper end of the front surface of the door, which is pressed by the user's hand, from moving and swing during the user's operation.

In addition, a door sheet is attached to the rear surface of the out plate made of metal, so that the foaming liquid may be evenly spread throughout the door. In particular, there is an advantage in that a relatively thinner second door sheet is disposed on the upper end of the out plate to secure a path for the foaming liquid to flow upward where the door opening device is disposed.

### BRIEF DESCRIPTION OF THE DRAWINGS

FIG. 1 is a perspective view illustrating a refrigerator according to an embodiment of the present disclosure.

FIG. 2 is an exploded perspective view illustrating the door.

FIG. 3 is an exploded perspective view illustrating the out plate and door sheet of the door.

FIG. 4 is a cross-sectional view taken along line 4-4 of FIG. 1.

FIG. 5 is an enlarged view illustrating part A of FIG. 4.

FIG. 6 is a perspective view illustrating the upper cap of the door.

FIG. 7 is a front view illustrating the upper cap.

FIG. 8 is an enlarged perspective view illustrating part B of FIG. 7.

FIG. 9 is a bottom view illustrating the upper cap.

FIG. 10 is a partial perspective view illustrating the flow state of the foaming liquid in the upper cap.

FIG. 11 is a cross-sectional view taken along line 11-11 of FIG. 10.

FIG. 12 is a front view illustrating an upper cap according to another embodiment of the present disclosure.

FIG. 13 is a perspective view illustrating an upper cap according to another embodiment of the present disclosure.

FIG. 14 is an enlarged front view illustrating the upper cap.

FIG. 15 is a cross-sectional view illustrating the flow state of the foaming liquid in the upper cap.

FIG. 16 is a perspective view illustrating a refrigerator door according to another embodiment of the present disclosure.

FIG. 17 is a cross-sectional view taken along line 17-17 of FIG. 16.

### DETAILED DESCRIPTION OF THE EMBODIMENTS

Hereinafter, specific embodiments of the present disclosure will be described in detail along with the drawings. However, the present disclosure cannot be said to be limited to the embodiments in which the idea of the present disclosure is presented, and other disclosures that are regressive or other embodiments included within the scope of the present disclosure can be easily suggested by adding, changing, or deleting other components.

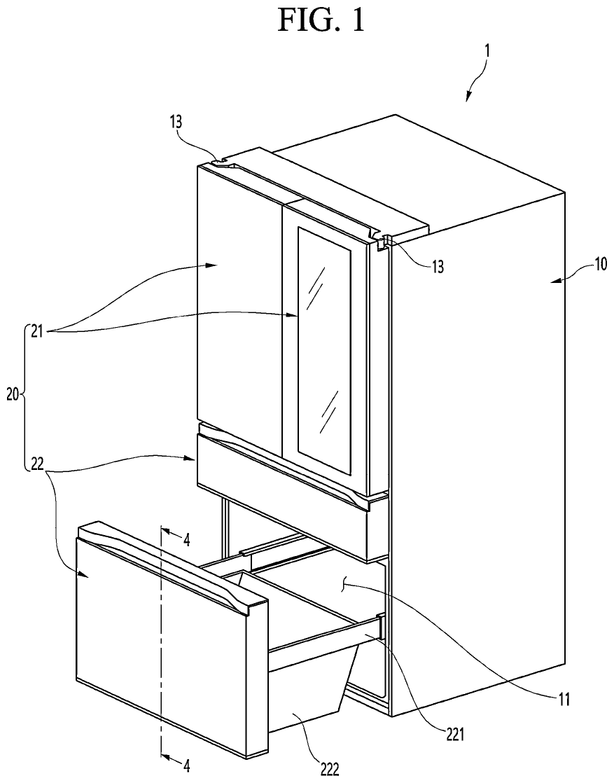

Before explaining, the direction is defined. In an embodiment of the present disclosure, the direction in which a front surface of the door illustrated in FIG. 1 faces may be referred to as a front direction, the direction toward the cabinet based on the front surface of the door may be referred to as a rear direction, the direction toward the floor where the refrigerator is installed may be referred to as a lower direction, and the direction away from the floor may be referred to as an upper direction.

FIG. 1 is a perspective view illustrating a refrigerator according to an embodiment of the present disclosure.

As illustrated, the refrigerator 1 according to an embodiment of the present disclosure may include a cabinet 10 forming a storage space and a door 20 opening and closing the storage space.

The storage space of the cabinet 10 may be divided into upper and lower sections. As an example, the storage space may include an upper storage space 11 located above and a lower storage space 12 located below. For example, the upper storage space 11 may be a refrigerating chamber and the lower storage space 12 may be a freezing chamber. In addition, if necessary, the upper storage space 11 and the lower storage space 12 may be divided into a plurality of spaces. Additionally, the upper storage space 11 and the lower storage space 12 may also be referred to as a first storage space and a second storage space.

The door 20 may include an upper door 21 that opens and closes the upper storage space 11 and a lower door 22 that opens and closes the lower storage space 12. The upper door 21 may be mounted on the cabinet 10 by a hinge 13 so that a pair of doors may be rotated on both left and right sides. In addition, the upper door 21 may open and close the upper storage space 11 by rotating. Therefore, the upper door 21 may be referred to as a rotary door.

The lower door 22 may be mounted on the cabinet 10 with a rail 221 so that the lower door may be slid in and out. In addition, the lower storage space 12 may be opened and closed by pulling in and out the lower door 22. Additionally, the lower door 22 may include a basket 222 at the rear surface of the door and may be configured in a drawer-like shape. Therefore, the lower door 22 may be referred to as a drawer-type door. Additionally, a plurality of lower doors 22 may be arranged.

The upper door 21 and lower door 22 may also be referred to as a first door and a second door.

In the embodiment of the present disclosure, it is stated in advance that a refrigerator of a type in which the storage space is arranged up and down is taken as an example, but the present disclosure is not limited to the shape of the refrigerator and the structure of the door, but the present disclosure may be applied to various types of refrigerators including a door structure including an out plate, a door cap, and an insulation material.

Hereinafter, the door structure will be described using the lower door 22 as an example, but since the door structure may be applied to both the upper door 21 and the lower door 22, the lower door 22 will be referred to as the door 20.

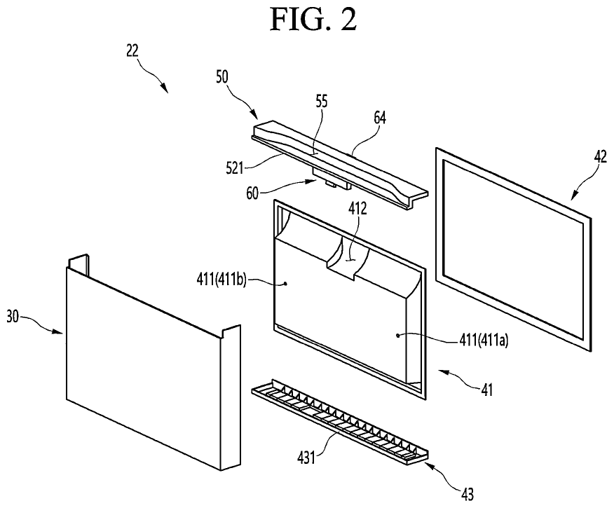

FIG. 2 is an exploded perspective view illustrating the door.

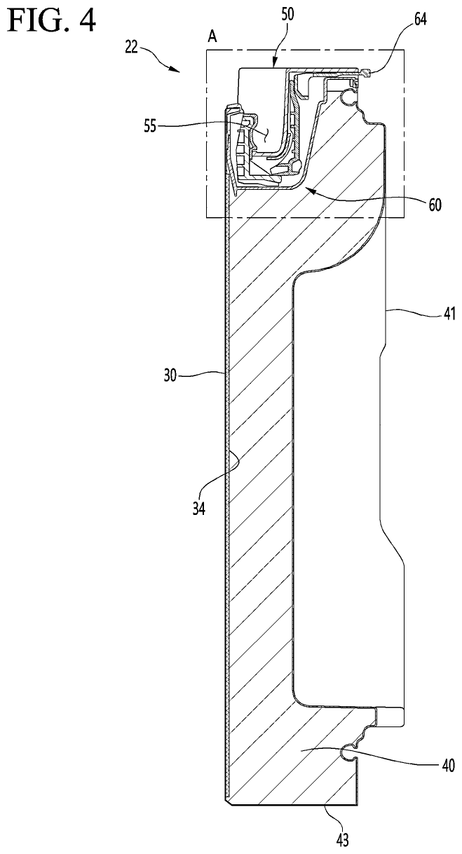

As illustrated, the door 20 may include an out plate 30 forming the front surface, a door liner 41 forming the rear surface, and door caps 50 and 43 forming the upper and lower surfaces. Additionally, the inside of the door 20 where the out plate 30, the door liner 41, and the door caps 50 and 43 are coupled may be filled with an insulation material (40 in FIG. 4).

The out plate 30 may form the front surface of the door 20. The out plate 30 may be formed of a plate-shaped metal material. For example, the out plate 30 may be made of stainless steel. Additionally, the out plate 30 may be bent at both ends to be coupled to the door liner 41 and form both sides of the door 20.

Additionally, the door liner 41 may be made of a plastic material and may form the rear surface of the door 20. Additionally, a liner recessed portion 241 may be formed in the door liner 41 to provide a space for the door opening device 60 to be placed. In addition, an injection hole 411 through which foaming liquid is injected may be formed in the door liner 41 for molding the insulation material 40. A plurality of injection holes 411 may be formed. For example, the injection holes 411 are spaced apart from each other on both left and right sides, and foaming liquid may be sequentially injected through each injection hole 411. As an example, the foaming liquid may be injected through the first injection hole 411a and then moved to inject the remaining foaming liquid through the second injection hole 411b. A gasket 42 may be provided along the rear circumference of the door liner 41.

The door caps 40 and 43 may include an upper cap 50 forming the upper surface of the door 20 and a lower cap 43 forming the lower surface of the door 20. In addition, the handle 55 may be formed on the upper cap 50. Of course, according to the position of the door 20, the handle 55 may be provided on the lower cap 43. Additionally, a door opening device 60 may be provided at the center of the upper cap 50 in the left and right direction. The door opening device 60 may be mounted on the handle 55. Therefore, the user can operate the door opening device 60 exposed within the handle 55, and when the door opening device 60 is operated, while the push member 64 protrudes rearward, the door 20 may open.

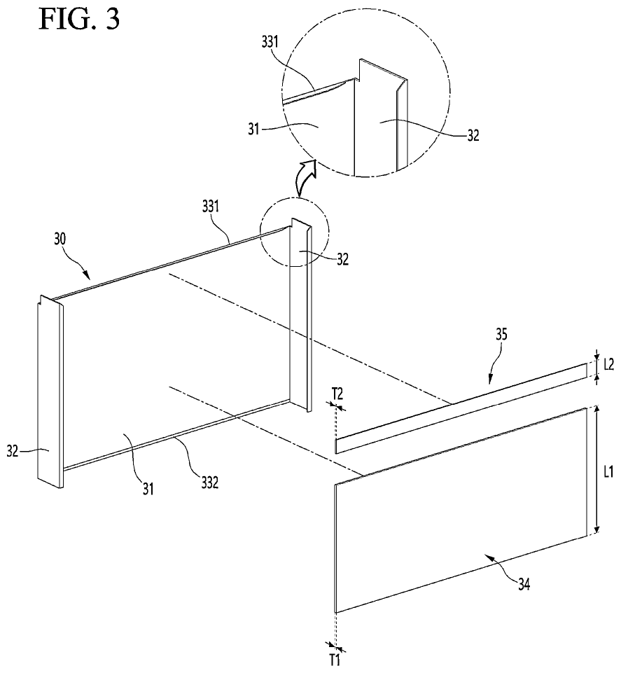

FIG. 3 is an exploded perspective view illustrating the out plate and door sheet of the door.

As illustrated, the out plate 30 may be formed by bending a plate-shaped metal material. The out plate 30 may include a front portion 31 that forms the front surface of the door 20, and side portions 32 that are bent backwards at both left and right ends of the front portion 31 to form both sides of the door 20. Of course, the out plate 30 may be composed of only the front portion 31 to form the front surface of the door 20.

Additionally, bending portions 331 and 312 may be formed at the upper end and the lower end of the front portion 31, respectively. The bending portion 311 is bent backward along the upper end of the front portion 31, and the bending portion 311 is inserted into the insertion groove 521 formed in the upper cap 50 so that the upper end of the out plate 30 and the upper cap 50 may be coupled to each other. Then, the bending portion 322 is bent backward along the edge of the front portion 31, and the bending portion 322 is inserted into the insertion groove 431 formed in the lower cap 43 so that the lower end of the out plate 30 and the lower cap 43 may be coupled to each other.

Additionally, the rear end of the side portion 32 may be bent inward and may be coupled to the door liner 41. Additionally, the upper end and the lower end of the side portion 32 may also be bent inward and coupled to the upper cap 50 and the lower cap 43.

Meanwhile, door sheets 34 and 35 may be attached to the rear surface of the out plate 30. The door sheets 34 and 35 may be attached to the front portion 31.

In detail, the door sheets 34 and 35 may include a first door sheet 34. The first door sheet 34 may be made of a compressible material, for example, polyurethane foam. The first door sheet 34 may be formed in a size corresponding to the horizontal width of the front portion 31. In addition, the first door sheet 34 may extend upward from the lower end of the front portion 31. In other words, the first door sheet 34 may cover most of the area of the front portion 31. The first door sheet 34 may prevent the out plate 30 from bending by distributing pressure when the foaming liquid is injected into the door 20. Additionally, the first door sheet 34 may disperse the foaming liquid injected into the door 20 so that the foaming liquid is evenly spread.

The door sheets 34 and 35 may further include a second door sheet 35. The second door sheet 35 may be made of a different material from the first door sheet 34. For example, the second door sheet 35 may be made of kraft tape. The second door sheet 35 may prevent the foaming liquid injected into the door 20 from directly attaching to the out plate 30.

The second door sheet 35 may be formed in a size corresponding to the horizontal width of the front portion 31. Additionally, the second door sheet 35 may extend upward from the upper end of the first door sheet 34. Additionally, the second door sheet 35 may extend to the upper end of the front portion 31. Additionally, the length L2 of the second door sheet 35 in the vertical direction may be shorter than the length L1 of the first door sheet 34 in the vertical direction. In other words, the second door sheet 35 is located at the upper end of the out plate 30 and has a length L2 in the vertical direction that may overlap with a portion of the door cap 50 or the door opening device 60.

Additionally, the thickness T2 of the second door sheet 35 may be thinner than the thickness T1 of the first door sheet 34. Therefore, in a state where the door caps 50 and 43 and the out plate 30 are coupled, a space may be secured for the foaming liquid to flow more smoothly toward the front part 52 of the upper cap 50. In addition, even when the door opening device 60 is mounted on the upper cap 50, the foaming liquid may flow smoothly into the insertion groove 521 of the upper cap 50.

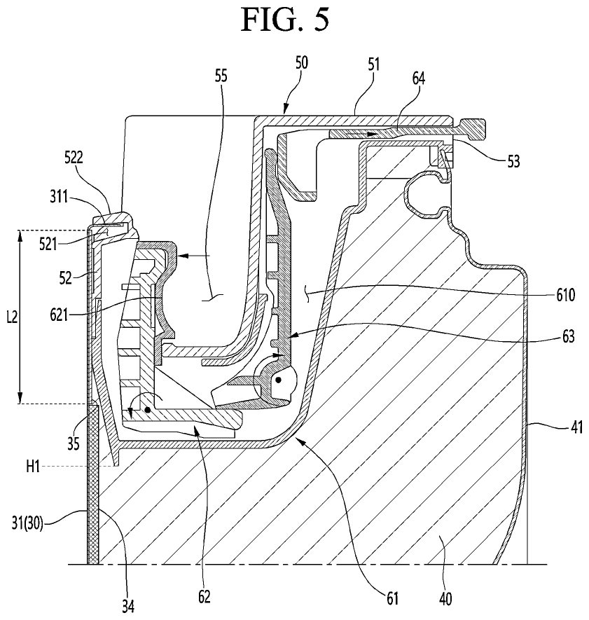

In addition, as illustrated in FIG. 5, at least a portion of the second door sheet 35 may overlap with the front part 52 of the upper cap 50 when the second door sheet 35 is attached. Additionally, at least a portion of the second door sheet 35 may overlap with the door opening device 60 in a state of being attached.

FIG. 4 is a cross-sectional view taken along line 4-4 of FIG. 1, and FIG. 5 is an enlarged view illustrating part A of FIG. 4.

As illustrated, the out plate 30 and the door liner 41 may be connected by the upper cap 50 and the lower cap 43. Additionally, the side portion 32 may be coupled to both sides of the door liner 41. Therefore, when in a case where the out plate 30, the door liner 41, and the door caps 50 and 43 are combined, a closed space may be formed inside the door 20 and the foam liquid may be injected through the injection hole 411 so that the insulation material 40 may be formed by filling the inside of the door 20.

A handle 55 recessed downward may be formed on the upper cap 50. The handle 55 may be located slightly forward relative to the center of the door 20 and may be recessed downward from the upper surface of the upper cap 50.

Additionally, a door opening device 60 may be mounted on the upper cap 50. The door opening device 60 is intended to assist in opening the door 20, and may be configured to be operated through the handle 55.

In detail, the door opening device 60 may include a case 61 mounted on the upper cap 50, an operation member 62 provided inside the case 61, a push member 64 protruding rearward when the operation member 62 is operated, and a link 63 arranged so that the operation member 62 and the push member 64 are interlocked.

The case 61 may be mounted on the lower surface of the upper cap 50. The case 61 forms a space 610 through which the insulation material 40 does not penetrate, and the operation member 62, push member 64, and link 63 may be arranged to be operable.

The operation member 62 may pass through the handle 55 and be exposed to the inside of the handle 55. Additionally, the operation member 62 may be disposed at the front of the inner surface of the handle 55. Accordingly, the user may operate the operation member 62 while holding the handle 55. The portion of the operation member 62 exposed through the handle opening 552 may be provided with a handle cover 621. The handle cover 621 may be formed of the same material as the handle 55.

The push member 64 slides inside the case 61 in the front and rear direction and may protrude rearwardly through the rear surface of the upper cap 50. In addition, the rear end of the push member 64 may be in contact with the cabinet 40. Accordingly, the push member 64 moves backward in conjunction with the operation of the operation member 62 and may assist in opening the door 20 by pushing the cabinet 10.

The link 63 and the operation member 62 are rotatably disposed and are configured to contact each other. Therefore, when operating the operation member 62, the operation member 62 may rotate the link 63. The link 63 may move the push member 64 backward by rotating the link. In addition, the link 63 or the push member 64 is provided with an elastic member so that the link 63 and the push member 64 may return to their original positions after operation of the operation member 62.

Meanwhile, a front part 52 may be formed on the front surface of the upper cap 50. The front part 52 may support the out plate 30 from the rear. Additionally, an insertion groove 521 may be formed in the upper portion of the front part 52. The bending portion 311 may be inserted into the insertion groove 521 to fix the upper end of the out plate 30.

Additionally, a support portion 522 may be formed at the upper end of the front part 52. The support portion 522 may restrain the upper end of the out plate 30, that is, the bending portion 311 from above. Additionally, the support portion 522 may form the outer appearance of the upper end of the front part 52. The support portion 522 may have a height slightly lower than the upper surface of the upper cap 50 and may be connected to the handle 55. Accordingly, the user's hand may easily approach the handle 55 through the support portion 522. In addition, when the user holds the handle 55, the door 20 may be opened and closed by holding the upper end of the out plate 30, the upper end of the front part 52, and the handle 55 together.

The front surface of the case 61 may be coupled to the lower end of the front part 52. In addition, the front surface of the case 61 is in contact with the out plate 30, that is, the front portion 31, so that the out plate 30 may be supported from the rear. At this time, at least a portion of the case 61 may be spaced apart from the out plate 30.

Meanwhile, the second door sheet 35 may extend downward from the upper end of the front portion 31 and may extend downward at least past the upper cap 50. Additionally, the second door sheet 35 may overlap the front surface of the door opening device 60.

For example, the length of the second door sheet 35 in the vertical direction may be located between the upper end of the front part 52 and the lower end H1 of the door opening device 60. Therefore, the foaming liquid may be moved upward into the space between the door opening device 60 and the out plate 30. To this end, the lower end of the front surface of the case 61 may be inclined to extend backward as it moves downward.

In addition, the upper end of the first door sheet 34 may extend to the lower end of the second door sheet 35. In other words, the upper end of the first door sheet 34 may extend upward past the lower end of the door opening device 60.

Hereinafter, the structure of the door cap will be described in more detail with reference to the drawings, taking the upper cap 50 as an example.

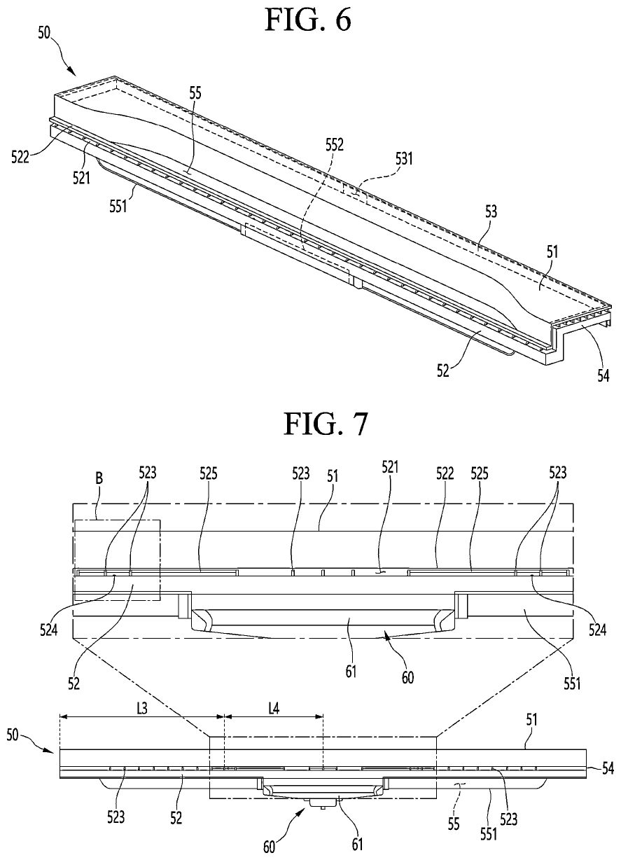

FIG. 6 is a perspective view illustrating the upper cap of the door.

As illustrated, the upper cap 50 may include an upper part 51, a front part 52, a rear part 53, and a side part 54.

In detail, the upper part 51 may form the upper surface of the upper cap 50 and may form the upper surface of the door 20. Additionally, a recessed portion 551 which is recessed downward is formed in the front half of the upper part 51, and the handle 55 may be formed by the recessed portion 551. The handle 55 may be formed at a slightly lower position than the upper part 51.

The front part 52 may form the front surface of the upper cap 50. The front part 52 may extend long in the left and right directions of the upper cap 50. The front part 52 may support the out plate 30 from the rear when the out plate 30 and the upper cap 50 are coupled. In addition, the insertion groove 521 and the support portion 522 may be formed in the upper part 51.

Additionally, a recessed portion 551 may be formed between the front part 52 and the upper part 51. In other words, the handle 55 may be disposed between the front part 52 and the upper part 51. Additionally, the front surfaces of the front part 52 and the recessed portion 551 may be spaced apart from each other, and the foaming liquid may flow into the interior. The door opening device 60 may be mounted in the recessed portion 551.

The rear part 53 is formed along the rear end of the upper part 51 and may form the rear surface of the upper cap 50. The rear part 53 may extend downward from the rear end of the upper part 51. The rear part 53 may be coupled to the upper end of the door liner 41. Additionally, a rear opening 531 may be formed in the rear part 53. The push member 64 may protrude rearward through the rear opening 531.

The side parts 54 are formed along both left and right ends of the upper part 51 and may form both left and right sides of the upper cap 50. The side part 54 may extend downward from both left and right ends of the upper part 51. In addition, the insertion groove 521 is formed to extend into the side part 54 so that the bent portion at the upper end of the side part 32 may be inserted thereinto. Accordingly, the side part 54 may be coupled to the upper end of both side surfaces of the out plate 30.

Hereinafter, the structure of the insertion groove 521 formed in the upper cap 50 will be described in more detail with reference to the drawings.

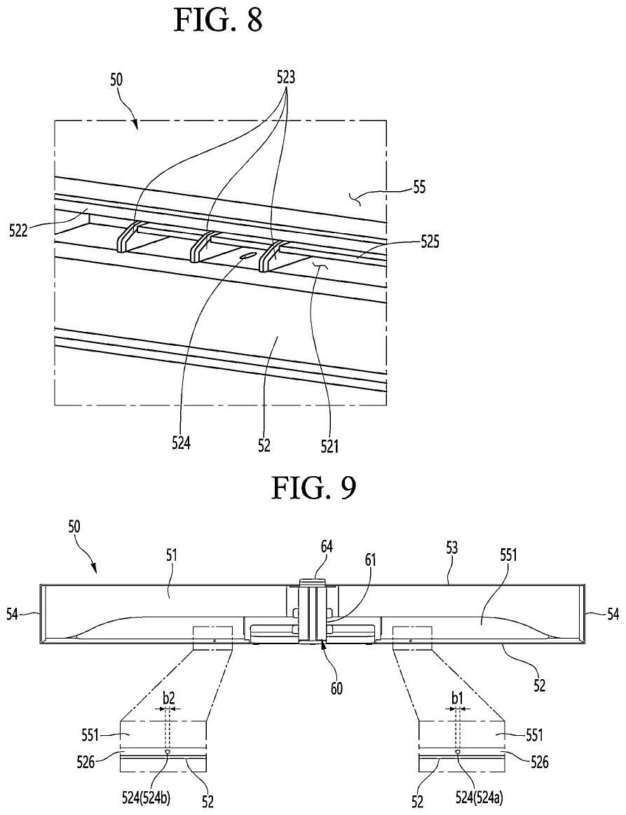

FIG. 7 is a front view illustrating the upper cap, FIG. 8 is an enlarged perspective view illustrating part B of FIG. 7, and FIG. 9 is a bottom view illustrating the upper cap.

As illustrated, the insertion groove 521 is recessed rearward in the upper part 51 and may be formed continuously from one end to the other end of the upper cap 50.

Additionally, a plurality of ribs 523 may be formed inside the insertion groove 521. The rib 523 may extend upward from the bottom 526 of the insertion groove 521 and may be spaced apart from the upper surface of the insertion groove 521. Therefore, when the bending portion 311 is inserted into the insertion groove 521, the bending portion may be supported by the rib 523. The rib 523 may have a low front end and a high rear end to facilitate insertion of the bending portion 311. The bending portion 311 may be fixed between the upper end of the rib 523 and the upper surface of the insertion groove 521 in a fully inserted state.

A plurality of ribs 523 may be provided and may be arranged continuously at regular intervals to ensure that the out plate 30 is stably fixed. Additionally, an inlet portion 524 through which the foaming liquid flows may be formed between the plurality of ribs 523.

The inlet portion 524 may be formed at the bottom 526 of the insertion groove 521. In addition, the inlet portion 524 may be formed in a size that allows the foaming liquid to flow in. For example, the inlet portion 524 may be formed in the shape of a hole penetrating the bottom 526 of the insertion groove 521. At this time, the inlet portion 524 may be formed to have a diameter of 1.2 mm to 3.0 mm. The inlet portion 524 may be formed between a plurality of ribs 523.

The inlet portion 524 may be formed between the left and right ends of the handle 55. Additionally, the inlet portion 524 may be formed at a location adjacent to the door opening device 60. As an example, the inlet portion 524 may be formed on both left and right sides away from the door opening device 60. If necessary, a plurality of inlet portions 524 may be formed on both sides of the door opening device 60, respectively.

At this time, the inlet portion 524 may be formed closer to the door opening device 60 at a midpoint between the outer end of the upper cap 50 and the end portion of the door opening device 60. If the inlet portion 524 is formed too far from the door opening device 60, the foaming liquid may not be sufficiently moved inside the insertion groove 521 where the door opening device 60 is located. On the other hand, even if the inlet portion 524 is formed too close to the door opening device 60, the flow of the foaming liquid may be obstructed by the case 61, preventing smooth flow of the foaming liquid through the inlet 524.

The inlet portion 524 may include a first inlet portion 524a and a second inlet portion 524b provided on both left and right sides, respectively. At this time, the first inlet portion 524a may be placed close to the first inlet portion 411a, and the second inlet portion 524b may be placed close to the second inlet portion 411b. Additionally, the first inlet portion 524a may have a smaller diameter than the second inlet portion 524b. For example, the diameter D1 of the first inlet portion 524a may be 2.5 mm, and the diameter D2 of the second inlet portion 524b may be 3.0 mm.

When foaming liquid is sequentially injected into the first injection hole 411a and the second injection hole 411b arranged on both sides of the door opening device 60, a portion of the foaming liquid first injected into the first injection hole 411a flows into the insertion groove 521 through the first inlet portion 524a, which has a narrow diameter. Then, a portion of the remaining portion of the foaming liquid to the second injection hole 411b flows into the insertion groove 521 through the second inlet portion 524b, which has a large diameter.

Therefore, when the foaming liquid is initially injected through the first injection hole 411a, the resistance inside the door 20 is relatively small, so a relatively large amount of the foaming liquid is injected. However, the diameter of the first inflow portion 524a is relatively small, making it possible to reduce the amount of foaming liquid flowing into the insertion groove 521. Then, when the foaming liquid is injected through the second injection hole 411b, the amount of the foaming liquid flowing into the insertion groove 521 through the second inlet portion 524b with a relatively larger diameter may increase. Accordingly, a uniform amount of foaming liquid may flow into the insertion groove 521 from both sides to fill the insertion groove 521.

Meanwhile, a plurality of ribs 523 may be disposed at regular intervals in the area L3 from the side end of the upper cap 50 to the inlet portion 524.

For smooth flow of the foaming liquid into the insertion groove 521 adjacent to the door opening device 60, a relatively small number of ribs 523 may be disposed in the area L4 from the inlet portion 524 to the center of the door opening device 60. Additionally, the ribs 523 disposed in the area L4 up to the center of the door opening device 60 may be disposed at relatively wider intervals.

The foaming liquid may flow more smoothly into the insertion groove 521 above the door opening device 60, and the insulation material 40 may fill the inside of the insertion groove 521. Accordingly, it is possible to prevent the out plate 30 from moving in the central portion of the handle 55, which frequently holds with his or her hand of the user to operate the door opening device 60.

A blocking portion 525 may be formed inside the insertion groove 521. The blocking portion 525 may prevent the foaming liquid flowing from the inlet portion 524 from leaking between the out plate 30 and the upper cap 50. The blocking portion 525 may extend along the insertion groove 521 and may be spaced apart above the inlet portion 524. Additionally, the blocking portion 525 may shield at least a portion of the inlet portion 524 from above. Accordingly, the foaming liquid that has passed through the inflow portion 524 is restricted from upward movement by the blocking portion 525 and may move laterally along the insertion groove 521.

The blocking portion 525 may be spaced apart from the upper surface of the insertion groove 521 and may protrude further forward than the inlet portion 524. Additionally, the blocking portion 525 may extend to pass through a plurality of ribs 523. At this time, the blocking portion 525 may be in contact with the upper end of the rib 523.

Hereinafter, the foaming liquid flow state of the door 20 having the above structure will be described in more detail with reference to the drawings.

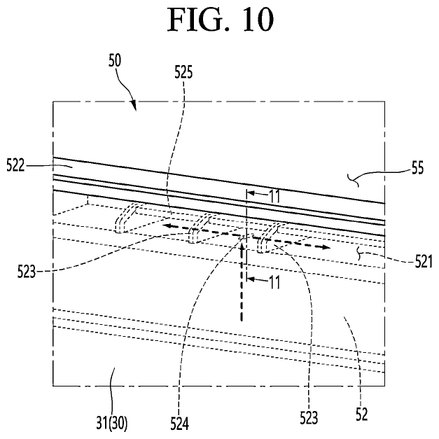

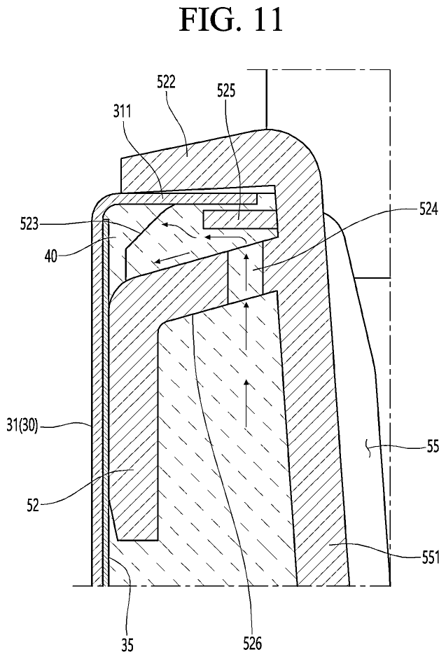

FIG. 10 is a partial perspective view illustrating the flow state of the foaming liquid in the upper cap, and FIG. 11 is a cross-sectional view taken along line 11-11 of FIG. 10.

As illustrated in the drawing, in a state where the out plate 30, the door liner 41, the upper cap 50, and the lower cap 43, which constitute the door 20, are coupled to each other, the foaming liquid may be injected into the door 20 through the injection hole 411. The foaming liquid may fill the inside of the door 20 and flow evenly inside the door 20.

Meanwhile, the bending portion 311 may be inserted into the insertion groove 521. The out plate 30 may be fixed to the upper cap 50 by inserting the bending portion 311. Additionally, the bending portion 311 may be in close contact with the support portion 522 and may be supported by the rib 523 inside the insertion groove 521.

In this state, some of the foaming liquid flowing into the door 20 may pass through the inlet portion 524 and flow into the insertion groove 521. The foaming liquid passing through the inlet portion 524 is restricted from upward movement by the upper blocking portion 525, and moves laterally along the insertion groove 521.

At this time, the central side where the door opening device 60 is disposed has fewer ribs 523, thereby reducing flow resistance. Accordingly, the foaming liquid that has passed through the inlet portion 524 flows to both left and right sides and may move more smoothly to the central portion where the door opening device 60 is located.

In addition, the foaming liquid that has passed through the inlet portions 524 on both sides entirely fills the insertion groove 521 above the door opening device 60. Then, the foaming liquid inside the insertion groove 521 is cured to form the insulation material 40. Ultimately, the inside of the insertion groove 521 may be filled with the insulation material 40. Accordingly, the upper end of the out plate 30 may be firmly fixed within the insertion groove 521 by the insulation material 40. In addition, even if the upper end of the door 20 is pressed from the front, the outer plate 30 does not move or deform because the insulation material 40 is filled therein.

In other words, even if the user applies force while holding the handle 55 to open or close the door 20, the outer plate 30 may be prevented from swinging. In particular, even if the operation member 62 is operated when opening the door 20, the upper end of the out plate 30 is firmly fixed and supported by the insulation material 40, so that the swing of the front surface of the door 20 This may be prevented.

Meanwhile, the present disclosure may be possible in various other embodiments in addition to the above-described embodiments. Another embodiment of the present disclosure is characterized in that a plurality of inlet portions are disposed on both sides of the operation member. Another embodiment of the present disclosure differs only in the arrangement of the inlet portion, and other configurations except the inlet portion are the same as the above-described embodiment, detailed descriptions and illustrations of the same configuration are omitted, and the same symbols are used to indicate the same configuration.

Hereinafter, with reference to the drawings, we will look at other embodiments of the present disclosure.

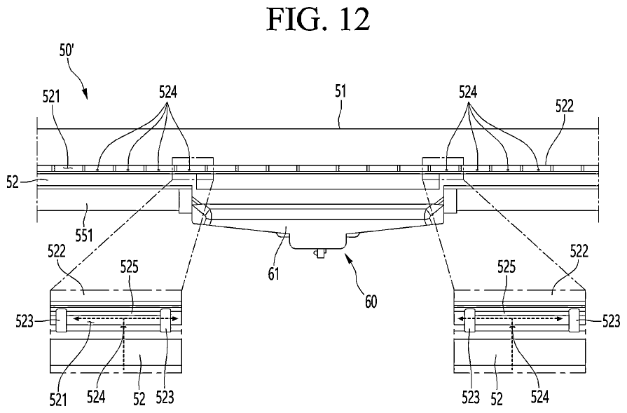

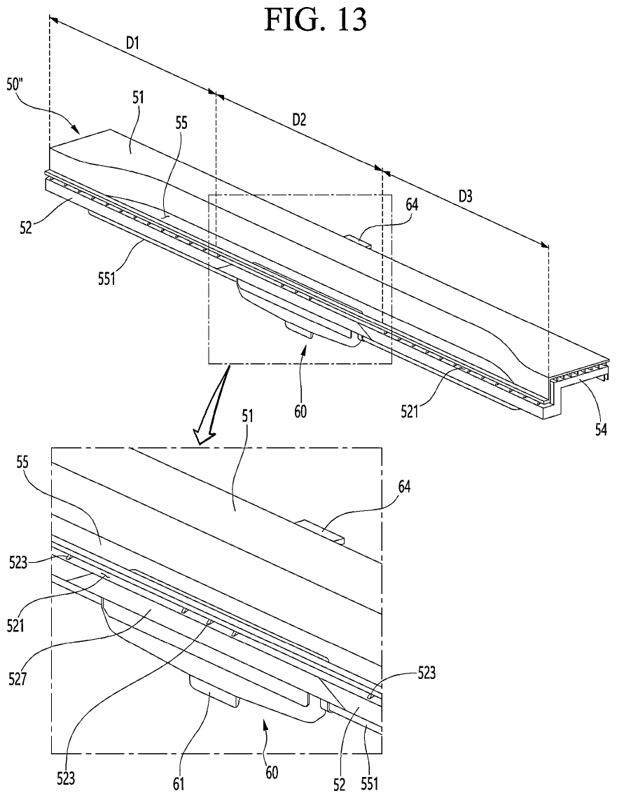

FIG. 12 is a front view illustrating an upper cap according to another embodiment of the present disclosure.

As illustrated, the door 20 of the refrigerator according to an embodiment of the present disclosure may be provided with a door cap 50′. Additionally, a handle 55 may be formed on the door cap 50′ by a downwardly recessed portion 551.

Additionally, a door opening device 60 may be mounted on the door cap 50′. The door opening device 60 may be located at the center of the door 20 in the left and right direction. Additionally, the door opening device 60 may be located at the center of the handle 55 in the left and right direction.

Additionally, the front part 52 of the door cap 50′ may support the out plate 30 from the rear. Additionally, an insertion groove 521 into which the bending portion 311 of the out plate 30 is inserted may be formed in the front part 52. A support portion 522 forming the upper end of the front part 52 may be formed on the upper side of the insertion groove 521. The support portion 522 supports the upper end of the out plate 30 and may be in contact with the upper surface of the bending portion 311.

A plurality of ribs 523 may be provided inside the insertion groove 521. Additionally, an inlet portion 524 may be formed at the bottom of the insertion groove 521. The inlet portion 524 may be formed in the shape of a hole penetrating the bottom of the insertion groove 521 and may be formed between the plurality of ribs 523.

A plurality of inlet portions 524 may be formed on both left and right sides with respect to the door opening device 60. For example, four inlet portions 524 may be formed on both left and right sides of the door opening device 60. Each of the inlet portions 524 may be formed at the bottom of the insertion groove 521 defined by the rib 523.

In addition, the opening diameter of the plurality of inlet portions 524 may be formed to be smaller as the inlet portion 524 is closer to the door opening device 60, and the diameter of the inlet portion 524 may be formed to be larger as the inlet portion 524 is farther from the door opening device 60.

When the foaming liquid flows into the insertion groove 521 through the plurality of inlet portions 524, a larger amount of foaming liquid may flow from the inlet portion 524 farther from the door opening device 60. Therefore, the foaming liquid may smoothly flow into the insertion groove 521 above the door opening device 60.

Meanwhile, the present disclosure may have various other embodiments in addition to the above-described embodiments. Another embodiment of the present disclosure is characterized in that the inlet portion is formed on the front surface of the front part. Another embodiment of the present disclosure differs only in the arrangement of the inlet portion, other configurations except the inlet portion are the same as the above-described embodiment, detailed descriptions and illustrations of the same configuration are omitted, and the same symbols are used to indicate the same configuration.

Hereinafter, with reference to the drawings, we will look at another embodiment of the present disclosure.

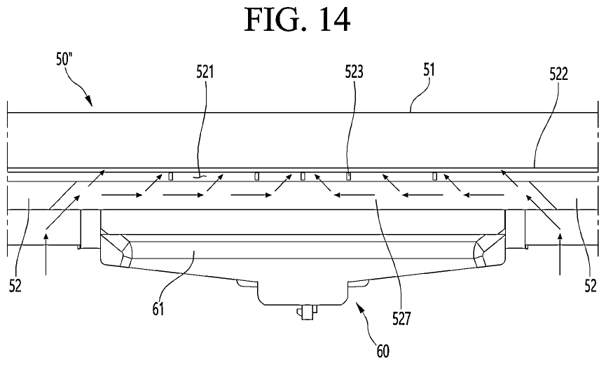

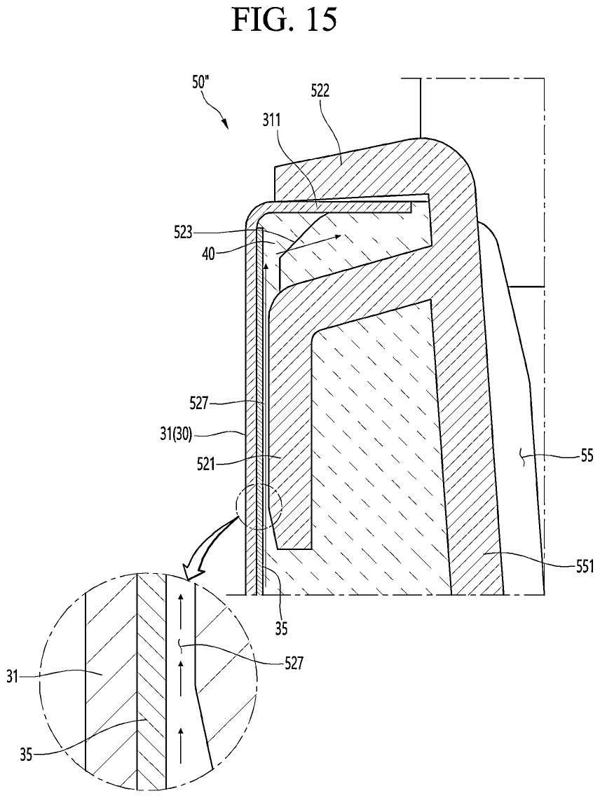

FIG. 13 is a perspective view illustrating an upper cap according to another embodiment of the present disclosure, FIG. 14 is an enlarged front view illustrating the upper cap, and FIG. 15 is a cross-sectional view illustrating the flow state of the foaming liquid in the upper cap.

As illustrated, the door 20 of the refrigerator according to an embodiment of the present disclosure may be provided with a door cap 50″. Additionally, a handle 55 may be formed in the upper part 51 of the door cap 50″ by a recessed portion 551 that is recessed downward.

Additionally, a door opening device 60 may be mounted on the door cap 50″. The door opening device 60 may be located in the center of the door in the left and right direction. Additionally, the door opening device 60 may be located at the center of the handle 55 in the left and right direction.

Additionally, the front part 52 of the door cap 50″ can support the out plate 30 from the rear. Additionally, an insertion groove 521 into which the bending portion 311 of the out plate 30 is inserted may be formed in the front part 52. A support portion 522 forming the upper end of the front part 52 may be formed on the upper side of the insertion groove 521. The support portion 522 supports the upper end of the out plate 30 and may be in contact with the upper surface of the bending portion 311. A plurality of ribs 523 may be provided inside the insertion groove 521.

An inlet portion 527 may be formed in the front part 52. The inlet portion 527 may be formed at the center of the door 20 in the left and right direction. Additionally, the inlet portion 527 may be formed at the center of the door cap 50″ in the left and right direction.

The inlet portion 527 may be formed by recessing the front surface of the front part 52. Accordingly, the inlet portion 527 may be formed to be stepped from the front surface of the front part 52. Additionally, the inlet portion 527 may extend from the lower end of the front part 52 to the insertion groove 521. Therefore, when the out plate 30 is coupled to the door cap 50″, the rear surface of the out plate 30 comes into contact with the front part 52, and a flow path through which the foaming liquid may pass may be formed between the out plate 30 and the inlet portion 527.

Additionally, the inlet portion 527 may be formed to be larger than the length of the door opening device 60 in the horizontal direction. Accordingly, the foaming liquid may pass through the inlet portion 527 and fill the insertion groove 521 above the door opening device 60.

Both left and right ends of the inlet portion 527 may be located further outside than both ends of the door opening device 60. In addition, both left and right ends of the inlet portion 527 may be formed to be inclined to face inward as it goes upward. Accordingly, the foaming liquid flowing through the inlet portion 527 may be guided upward to the door opening device 60 through the inlet portion 527.

When the foaming liquid is injected into the door 20, the inside of the insertion groove 521 is filled through the inlet portion 527, and the foaming liquid is cured to form the insulation material 40. At this time, the insulation material 40 is filled with the inside of the insertion groove 521 and the inlet portion 527, so that the out plate 30 may be firmly supported at the upper end of the door 20. Therefore, when the user operates the door 20, it is possible to prevent movement and swing at the upper end of the front surface of the door 20, especially at a position adjacent to the door opening device 60.

Meanwhile, the present disclosure may have various other embodiments in addition to the above-described embodiments. Another embodiment of the present disclosure is characterized in that an inlet portion is formed in the door cap of a rotary refrigerator door. In other embodiments of the present disclosure, the only difference is the object of application, and the arrangement structure of the insertion groove and the inlet portion may be the same. For the same configuration as the above-described embodiment, detailed description and illustration thereof will be omitted and the same symbols will be used to indicate the same configuration.

Hereinafter, with reference to the drawings, we will look at another embodiment of the present disclosure.

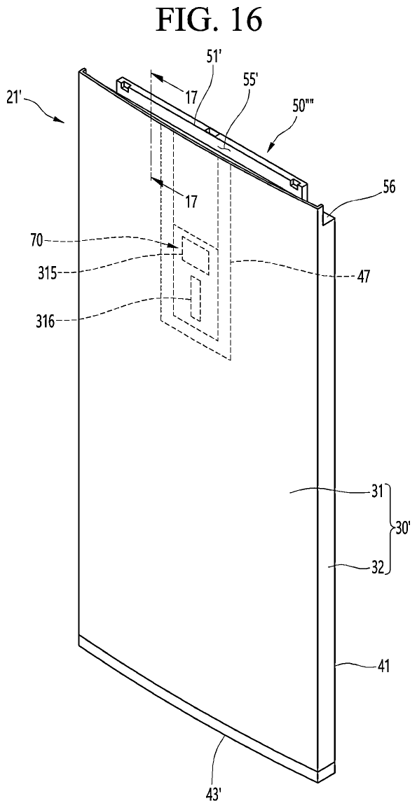

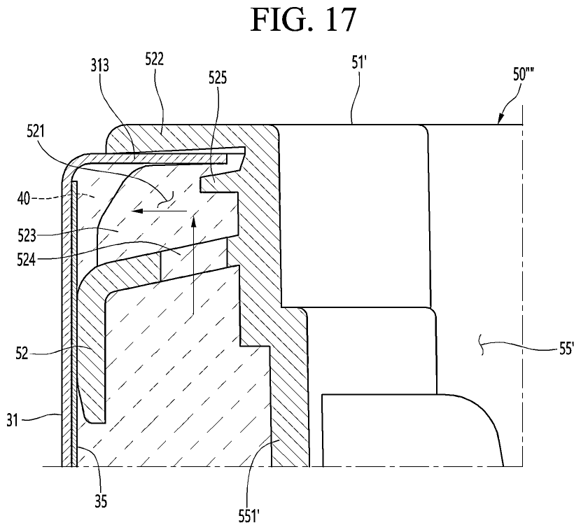

FIG. 16 is a perspective view illustrating a refrigerator door according to another embodiment of the present disclosure, and FIG. 17 is a cross-sectional view taken along line 17-17 of FIG. 16.

The front surface of the refrigerator door 21′ according to another embodiment of the present disclosure is formed by an out plate 30′, and a door liner 41 may be provided at the rear of the out plate 30′. In addition, the out plate 30′ and the door liner 41 may form the upper and lower surfaces of the door 21′ by the upper cap 50′ and the lower cap 43′.

In addition, in the out plate 30′ and the door liner 41, in a state where the upper cap 50″ and the lower cap 43′ are coupled, foaming liquid may be injected inside the door 21′ to form the insulation material 40 inside the door 21′.

The out plate 30′ may be formed of a metal material, and include a front portion 31 that forms the front surface of the door 21′, and a side portion 32 that forms both left and right sides of the door 21′. The out plate 30′ may be formed by bending a plate-shaped material to form the front portion 31 and the side portion 32.

Meanwhile, the front portion 31 may include a display unit 315 for displaying operation information and an operation portion 316 for touch operation by the user. The display unit 315 may be formed by opening the front portion 31. As an example, the display unit 315 may be composed of a number of fine holes. Additionally, the operation portion 316 may be formed by surface processing or printing.

Additionally, a hinge mounting portion 56 may be formed on one side of the upper cap 50″. A hinge connecting the door 21′ and the cabinet 10 may be mounted on the hinge mounting portion 56. Accordingly, the door 21′ may be opened and closed by rotation. As an example, the door 21′ may have the structure of the upper door 21 illustrated in FIG. 1 in the above-described embodiment.

A recessed portion 551 which is recessed downward may be formed in the upper cap 50″. The recessed portion 551′ may communicate with the display case 47 provided inside the door 21′. Additionally, an opening 55′ into which the display assembly 70 is inserted may be formed by the recessed portion 551′.

The display case 47 may form a space inside the door 21′ into which the insulation material 40 does not penetrate. Additionally, the display assembly 70 may be inserted and mounted inside the display case 47. The display assembly 70 may be inserted through the recessed portion 551′ of the upper cap 50″. The display assembly may be equipped with a display device or LED displayed as the display unit. Additionally, the display assembly 70 may include a touch sensor.

The display assembly 70 may be provided at a position corresponding to the display unit 315. Additionally, the display assembly 70 may be provided at a position corresponding to the display unit 315.

The upper cap 50″ may include an upper part 51′ forming the upper surface and a front part 52 forming the front surface. The front part 52 may support the out plate 30′ from the rear.

Additionally, an insertion groove 521 may be formed in the front part 52 into which the bending portion 313 bent backward from the upper end of the out plate 30′ is inserted. Inside the insertion groove 521, a rib 523 protrudes upward and may support the bending portion 313 from below. A support portion 522 may be formed at the upper end of the front part 52. The support portion 522 forms the upper end of the front part 52 and may be in contact with the upper surface of the bending portion 313. Accordingly, the bending portion 313 may be inserted between the support portion 522 and the rib 523 and fixed within the insertion groove 521.

Additionally, an inflow portion 524 may be formed at the bottom of the insertion groove 521 to form a passage through which the foaming liquid flows into the inside of the insertion groove 521. The inlet portion 524 may be formed in the shape of a hole penetrating the bottom of the insertion groove 521. Additionally, a shield portion 525 may protrude above the insertion groove 521. The shielding portion 525 may protrude forward and shield at least a portion of the inlet portion 524 when viewed from above. Additionally, the shielding portion 525 may extend further forward than the extended end portion of the bending portion 313. Accordingly, the foaming liquid may be prevented from leaking through the coupling portion of the out plate 30′ and the door cap 50″″.

When the foaming liquid is cured after completion of injection, the insulation material 40 may be formed. At this time, the insulation material 40 may also be formed inside the insertion groove 521, and the out plate 30′ may be fixed more firmly. Accordingly, it is possible to prevent the out plate 30′ from flowing or swinging at the upper end of the front surface of the door 21′.

Accordingly, even if the user touches the front surface of the door 21′ to operate the operation portion 316, the out plate 30′ does not move, thereby improving the user's operating feeling. In addition, even when the user presses the front surface of the door 21′ to open the door 21′, the out plate 30′ does not move, thereby improving the user's operating feeling.

Additionally, if necessary, a recessed handle like the above-described embodiment may be formed on the lower cap 43′. Additionally, the insertion groove 521 and the inlet portion 524 may be formed in the lower cap 43′.

What is claimed is:

1. A refrigerator comprising:
a cabinet forming a storage space; and
a door configured to open and close the storage space,
wherein the door includes:
an out plate having a bending portion that forms a front surface of the door made of metal and is bent backward;
a door liner forming a rear surface of the door;
a door cap having an insertion groove that connects the out plate and the door liner to form an outer surface of the door and into which the bending portion is inserted; and
an insulation material formed by injecting a foaming liquid into the inside of the door, and
wherein an inlet portion is formed in the door cap, which communicates with the insertion groove and guides the foaming liquid into the insertion groove.

2. The refrigerator of claim 1,
wherein a recessed handle is formed in the door cap so that a user can hold the handle to open the door.

3. The refrigerator of claim 2,
wherein the door cap includes:
an upper door cap forming an upper surface of the door, and
a lower door cap forming a lower surface of the door, and
wherein the handle and an inlet portion are formed on the upper door cap.

4. The refrigerator of claim 3,
wherein the door cap includes:
a front part configured to support the out plate from the rear and in which the insertion groove is formed, and
wherein the inlet portion penetrates the bottom of the insertion groove connecting the handle and the front part.

5. The refrigerator of claim 1,
wherein the door cap includes:
a front part configured to support the out plate from the rear,
wherein the insertion groove is recessed in the front part, and
wherein the inlet portion is formed in a shape of a hole penetrating the bottom of the insertion groove.

6. The refrigerator of claim 5,
wherein the insertion groove is provided with a plurality of ribs configured to support the bending portion, and
wherein the inlet portion is located between the plurality of ribs.

7. The refrigerator of claim 5,
wherein a pair of injection holes through which the foaming liquid is sequentially injected is formed at the door, and
wherein a pair of the inlet portions are spaced apart from each other, and the diameter of the inlet portion closest to the injection hole through which the foaming liquid is first injected is smaller than the diameter of the other inlet portion.

8. The refrigerator of claim 5,
wherein a blocking portion is formed inside the insertion groove, and
wherein the blocking portion protrudes to block at least a portion of the inlet portion from above.

9. The refrigerator of claim 8,
wherein the insertion groove is provided with a plurality of ribs configured to support the bending portion, and
wherein the blocking portion extends to pass through a plurality of ribs.

10. The refrigerator of claim 1,
wherein the door cap includes:
a handle recessed to put the user's hand therein; and
a door opening device including an operation member configured to operate by the user and a push member configured to push the cabinet to open the door in conjunction with the operation of the operation member, and
wherein the plurality of inlet portions are disposed on both sides of the door opening device.

11. The refrigerator of claim 10,
wherein the insertion groove extends from the front of the door opening device to pass through the door opening device in left and right direction, and
wherein the foaming liquid flowing into the inlet portion fills the insertion groove above the door opening device.

12. The refrigerator of claim 10,
wherein the inlet portion includes of a plurality of holes disposed at regular intervals, and
wherein the plurality of inlet portion are formed so that the diameter of the holes becomes larger as the distance from the door opening device increases.

13. The refrigerator of claim 1,
wherein the door cap includes:
a front part configured to support the out plate from the rear,
wherein the insertion groove and the inlet portion are formed at the front part, and
wherein the inlet portion is recessed from the lower end of the front part to the insertion groove, and the foaming liquid passes between the out plate and the inlet portion and heads toward the insertion groove.

14. The refrigerator of claim 13,
wherein the inlet portion is formed to be stepped from the front surface of the front part.

15. The refrigerator of claim 13,
wherein a plurality of ribs are formed along the insertion groove, and
wherein a greater number of the plurality of ribs are disposed in an area outside the inlet portion than in an area of the inlet portion with respect to the inlet portion.

16. The refrigerator of claim 1,
wherein a door sheet in contact with the foaming liquid is provided on a rear surface of the out plate,
wherein the door sheet includes:
a first door sheet extending upward from the lower end of the out plate; and
a second door sheet disposed above the first door sheet, and
wherein the first door sheet and the second door sheet are formed of different materials.

17. The refrigerator of claim 16,
wherein the first door sheet is made of a compressible material and is thicker than the second door sheet.

18. According to claim 16,
wherein the door cap is provided with a door opening device that assists in opening the door, and
wherein at least a portion of the second door sheet overlaps the door opening device.

19. The refrigerator of claim 1, further comprising:
a rail connecting the door and the cabinet and configured to opening and closing the storage space by pulling the door in and out.

20. The refrigerator of claim 1, further comprising:
a hinge connecting the door and the cabinet and configured to opening and closing the storage space by rotating the door.
